(19) United States
(12) Patent Application Publication
(10) Pub. No.: US 2013/0135515 A1
(43) Pub. Date: May 30, 2013

(54) DIGITAL IMAGING SYSTEM

(71) Applicant: SONY Corporation, Tokyo (JP)

(72) Inventors: Mohammed Abolfadl, Stuttgart (DE); Zoltan Facius, Esslingen (DE)

(73) Assignee: SONY Corporation, Tokyo (JP)

(21) Appl. No.: 13/684,446

(22) Filed: Nov. 23, 2012

(30) Foreign Application Priority Data
Nov. 30, 2011 (EP) 11 009 456.2

(51) Int. Cl. H04N 5/225

(52) U.S. Cl. CPC H04N 5/225
USPC 348/340

(57) ABSTRACT

A digital imaging system for imaging an object is provided comprising a photosensor array arranged in an image plane and a plurality of microlenses arranged so as to direct light from the object to the photosensor array. The plurality of microlenses have different focal lengths and different fields of view.

### CROSS REFERENCE TO RELATED APPLICATION

The present application claims the benefit of the earlier filing date of 11 009 456.2 filed in the European Patent Office on Nov. 30, 2011, the entire content of which application is incorporated herein by reference.

An embodiment of the invention relates to a digital imaging system.

### BACKGROUND

A light-field camera is a camera which uses a microlens array to capture 4D information of the light rays passing the optical system (radiance as a function of position and direction). Currently two light-field camera designs are known, which both use a main lens and a lens array (or pinhole grid) in front of a photosensor. The main difference between both designs is the relative position of the microlens array and the image plane of the main lens and the relative position of the focal plane of the microlenses and the photosensor.

In a first approach, which is known as “Plenoptic 1.0” or integral imaging from Lippmann and which is also described in WO 2007/092581 A2, the microlens array is positioned at the image plane of the main lens, directly in front of the photosensor so that a blurred image spot is projected onto the photosensor. The effective resolution of this light-field camera is the same as the number of microlenses of the lens array.

In a second approach the lens array is arranged such that multiple low-resolution micro images of a “virtual” image of the object generated by the main lens are projected onto the photosensor. The distance between the micro lens array and the image plane at which the photosensors are located does not equal the focal length of the microlenses. This latter approach is known as “Plenoptic 2.0”, which can achieve a higher effective resolution than “Plenoptic 1.0”. It is described in US 2009/0041448 A1.

In a further development of “Plenoptic 2.0” (“Plenoptic 2.0 modified”) a microlens array with a plurality of microlenses is used which differ in their focal lengths. Each group of microlenses of a particular focal length focuses a different range of depth of the “virtual” image space onto the photosensor. With this measure the field of depth of the whole imaging system is extended since virtual images at different distances from the microlens array can be brought into focus on the photosensor plane simultaneously and a relatively high effective resolution is achieved for “virtual” objects which are located near to the imaging system, i.e. near to the microlens array and to the photosensor.

All known system have in common that the effective resolution of the imaging system decreases rapidly over the range of depth.

Thus, there is a need for a digital imaging system with a high effective resolution over a large range of depth.

This object is solved by a digital imaging system comprising the features of claim 1.

The digital imaging system of the preferred embodiment comprises a photosensor array arranged in an image plane and a plurality of microlenses arranged so as to direct light from the object to said photosensor array, wherein said plurality of microlenses have different focal lengths and different field of views.

An investigation was made to find out the reason for the rapid decrease of the effective resolution over the range of depth. It was found out that a reason for the rapid decrease is that the micro images generated by neighbouring microlenses do contain for the most part the same information, and that only a small part of the information generated by neighbouring microlenses differs from each other. That is that each micro image is a shifted version of its neighbouring image, shifted by only a small amount. Therefore, the photosensor space is not utilised in an optimal manner since much redundant information is saved. It was found out that less redundant information between micro images generated by neighbouring microlenses would give a more unique resolution for each micro image generated at the image plane. It was further found out that less redundant information between neighbouring micro images can be achieved by a plurality of microlenses having different focal lengths and different field of views. With this arrangement the microlenses are focusing at different “virtual” image planes with different field of views so that the range of depth is divided in several sub-ranges. For example, when using microlenses with four different field of views the range of depth is divided into four sub-ranges. Preferably the microlenses with the largest field of view are focused on near objects, and the microlenses with the narrowest field of view are focused on far objects of the captured scene. With this arrangement the overlap between adjacent microlenses can be minimized, resulting in a high effective resolution over a large range of depth.

Further features and advantages of the invention read from the following description of embodiments in accordance with the present invention and with reference to the drawings.

### BRIEF DESCRIPTION OF THE SEVERAL VIEWS OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following description. The elements of the drawings are not necessarily to scale relative to each other. Like reference numerals designate corresponding similar parts.

FIG. 1 schematically shows the optical geometry of an imaging system according to an embodiment of the present invention;

FIG. 2 schematically shows the raw output resolution as a function of the object distance from the camera of light-field cameras known from the prior art and the expected raw output resolution of a digital imaging system according to the present invention as a function of the distance of the object from the camera;

FIG. 3 schematically illustrates the operation of two types of microlenses differing both in their focal lengths and their field of views;

FIG. 4 schematically illustrates the geometrical dependencies of a microlens having an angle of view θ_{fov};

FIG. 5 schemtically shows a preferred arrangement of the present invention in which two groups of microlenses having both different focal lengths and different fields of view are arranged in a common plane;

FIGS. 6a and 6b schematically illustrate the raw output resolution over the range of depth of an imaging system according to the present invention comprising microlenses having both different focal lengths and different fields of view;

FIG. 7 schematically illustrates the number of common pixels over the range of depth of an imaging system according to the present invention comprising microlenses having both different focal lengths and different fields of view;

FIG. 8 schematically shows a preferred configuration of the microlenses of the digital imaging system according to the present invention;

FIG. 9a shows a preferred distribution of three types of in a hexagonal grid and FIG. 9b shows a further preferred distribution of microlenses arranged in a rectangular array comprising four different types of microlenses which differ both in their focal lengths and their fields of view; and

FIG. 10a schematically illustrates micro images generated by a microlens array with four different groups of microlenses having different focal lengths and different fields of view on a photosensor array of an imaging system according to the present invention.

FIG. 10b schematically illustrates in colour the micro images of FIG. 10a, wherein it can be seen that the micro images represent a part of a scene.

### DETAILED DESCRIPTION

In the following, embodiments of the invention are described. It is important to note that all described embodiments in the following may be combined in any way, i.e. there is no limitation that certain described embodiments may not be combined with others. Further, it should be noted that same reference signs throughout the figures denote same or similar elements.

It is to be understood that other embodiments may be utilized and structural or logical changes may be made without departing from the scope of the invention.

The following detailed description, therefore, is not to be taken in a limiting sense, and the scope of the present invention is defined by the appended claims.

It is to be understood that the features of the various embodiments described herein may be combined with each other, unless specifically noted otherwise.

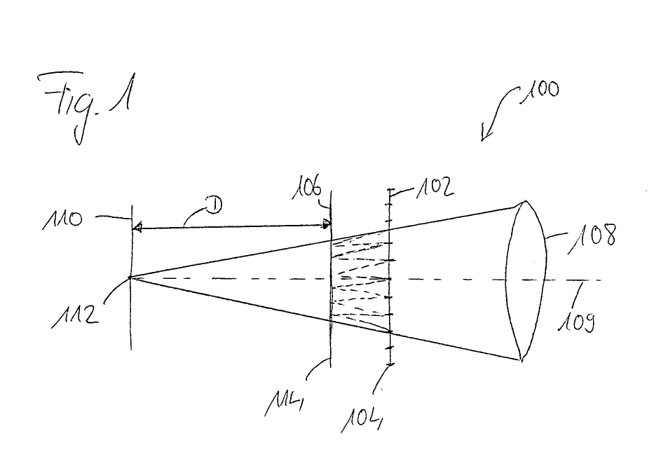

FIG. 1 schematically shows the optical geometry of an imaging system 100 of a light-field camera. The imaging system 100 has a plurality of microlenses 102 arranged in a microlens array 104 and a photosensor array 106 comprising a plurality of photosensors. A main lens 108 with an optical axis 109 focuses the light emanating from or reflecting of an object (not shown) which is located on the right side of the main lens 108 onto a surface 110 on its left thereby forming a “virtual” image 112. The main lens 108 is preferably a conventional camera lens. The image 112 is a “virtual” image in the sense that it is not formed on the plane at which the photosensor array 106 is arranged. The microlens array 104 is placed in front of the plane of the photosensor array 106. The photosensor array 106 is arranged in an image plane 114. The diameter of each of the microlenses 102 can be chosen to be larger than the diameter of a single photosensor such that each microlens 102 can generate an image on multiple photosensors of the photosensor array 106. The photosensor array 106 is for example a CCD matrix or a line array. The microlens array 104 is arranged such that it can project a plurality of images of the “virtual image” onto the photosensor array 106. The image generated by a microlens 102 on the photosensor array 106 is called a micro image. A micro image can be made of a plurality of photosensors. The microlens array can be a chirped type lens array.

The microlenses 102 in the microlens array 104 act as small cameras which record different views of the “virtual” image. The various micro images can be used to computationally simulate a virtual image plane such that the resultant image is in focus for those parts of the “virtual” image that intersect with the virtual image plane. For focussing different parts of the object the virtual image plane has to be moved along the optical axis 109. This movement is made computationally so that the image can be refocused after a raw image has been recorded. There is no restriction on the form of the virtual image plane so that instead of a virtual image plane also an arbitrarily shaped virtual image surface can be simulated.

When using microlenses 102 with different focal lengths in the microlens array 104 depending on their focal length the microlenses 102 focus a particular range of depth of the “virtual” image space onto the image plane 114 at which the photosensor array 106 is located so that different ranges of depths of a “virtual” image 112 are focused onto the photosensor array 106. Thus, the field of depth of the whole imaging system 100 can be extended compared to an imaging system 100 comprising a microlens array 104 with microlenses 102 of a unique focal length.

FIG. 1 shows the “virtual” image 112 being located with a distance D to the image plane 114. The nearer the “virtual” image 112 is to the image plane 114, i.e. the smaller the distance D is, the further away the object is from the camera and the less microlenses 102 see the same point. And vice versa, the closer an object is to the camera, the further away the “virtual” image 112 is from the image plane 114 and the more microlenses 102 see the same point. The effective resolution is a combination of the number of microlenses 102 a point is projected to and the field of depth of the microlenses 102. Thus, the effective resolution decreases for objects located further away from the camera.

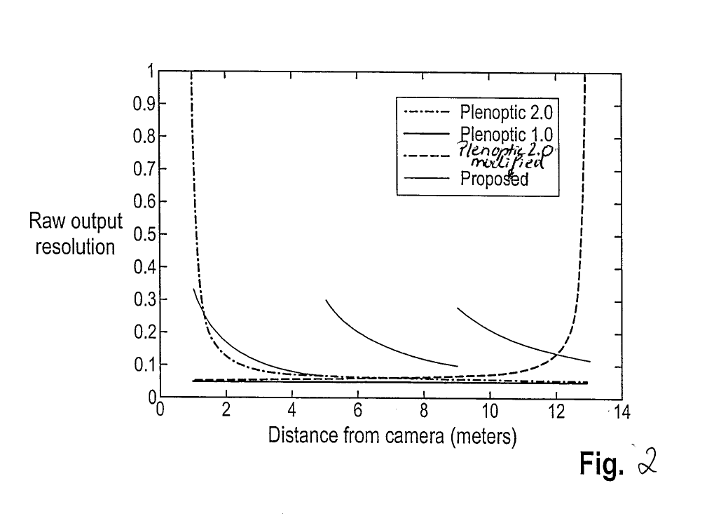

FIG. 2 shows the “raw output resolution” as a function of the object distance from the camera of light-field cameras known from the prior art, i.e. of a light-field camera of the type “Plenoptic 1.0”, of the type “Plenoptic 2.0” and of the type “Plenoptic 2.0 modified” using microlenses with different focal lengths. The “raw output resolution” is the maximum resolution that can be generated computationally from the raw image data generated by the light-field camera without any further digital processing (interpolation, super-resolution etc.). It depends on the distance D of the virtual image to the microlens plane, the field of depth of the microlenses and the resolution of the photosensor plane. As can be seen from this drawing, with the light-field camera of type “Plenoptic 2.0” a higher raw output resolution is achieved compared to imaging with a light-field camera of type “Plenoptic 1.0”. As can be further observed, the resolution exponentially decreases for objects located further away from the camera, i.e. when the “virtual” image 112 is located closer to the photosensor array 106 of the imaging system 100. This loss of resolution for objects located further away from the camera is reduced for a light-field camera of type “Plenoptic 2.0 modified” using microlenses 102 with different focal lengths, as can be also seen from FIG. 2 of the drawings. Further, FIG. 2 also shows the expected raw output resolution of a digital imaging system according to the present invention as a function of the distance of the object from the camera. As can be seen, with the imaging system according to the present invention comprising microlenses having different focal lengths and different fields of view an enhanced resolution over a large range of depth can be achieved compared to that of digital imaging systems known from the prior art. Thus, compared to a light-field camera of the type “Plenoptic 2.0” a better average resolution of 22% is expected and compared to a light-field camera of type “Plenoptic 2.0 modified” a better average resolution of 12% is expected.

From the above explanations it becomes clear that all known imaging systems with an enhanced effective resolution suffer in that their effective resolution decreases exponentially over the range of depth. Specifically, in the case of “Plenoptic 2.0” the resolution rapidly decreases for objects being located further away from the camera, and in the case of “Plenoptic 2.0 modified” the resolution rapidly decreases for objects located nearer to the camera.

The inventors of the digital imaging system according to the present application found out that a reason for the rapid decrease of the effective resolution over the range of depth is that the micro images generated by adjacent microlenses contain for the most part the same information, and that only a small part of the information generated by adjacent microlenses differs from each other. The micro images generated by adjacent microlenses are shifted with each other by a small amount, thereby including for the most part the same information. This is due to the fact that the “virtual” images seen by neighbouring microlenses and projected onto the photosensor array are overlapping to a great extent. Therefore, the photosensor space is not utilised in an optimal manner since much redundant information is saved.

Thus, the inventors further made investigations in finding out how to avoid this overlapping of adjacent microlenses in order to achieve the best resolution per depth over a large range of depth.

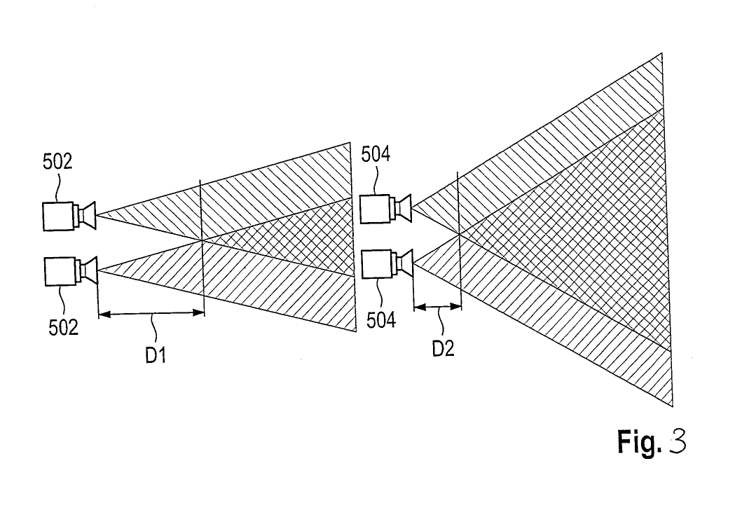

FIG. 3 schematically illustrates the operation of two types of microlenses 502, 504 differing both in their focal lengths and their field of views (FOV). On the left side of FIG. 3 the operation of microlenses 502 with a relatively narrow field of view and on the right side the operation of microlenses 504 with a relatively wide field of view is shown. Further, the microlenses 502 with a relatively narrow field of view are preferably selected so as to have a smaller focal length compared to the microlenses with a relatively wide field of view. As can be seen, adjacent microlenses 502 with the narrower field of view can project micro images of a virtual image in a first range of depth D1 without overlapping image information, and adjacent microlenses with the wider field of view can project micro images of a virtual image in a second range of depth D2 without overlapping image information. The microlenses 502 with a narrower field of view preferably have a greater focal length than the microlenses 504 with a wider field of view so that the microlenses 504 with the wider field of view are focused to “virtual” objects located nearer to the microlenses 504 than the microlenses 502 with a narrower field of view and the greater focal length. So, by using two types of microlenses 502, 504 having different focal lengths and different field of views the range of depth is divided into sub-ranges of depth in which the image information focused by adjacent microlenses does not substantially overlap each other. Such a microlens array comprising microlenses with different focal lengths and different fields of view can be integrated into the imaging system 100 as is schematically illustrated in FIG. 1 of the drawings for achieving the effects discussed above and below.

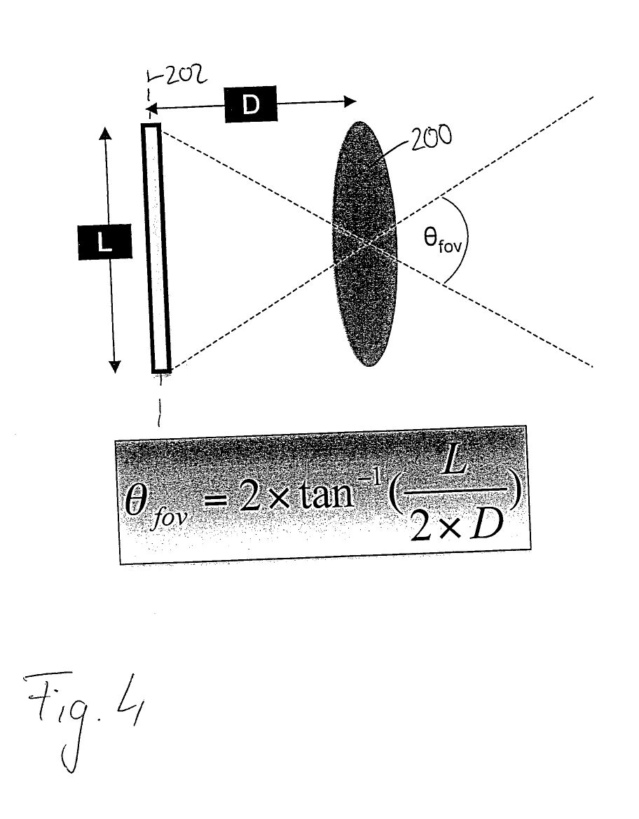

FIG. 4 shows the dependancies of a lens 200 with an angle of view θ_{fov}, a distance D to a plane 202, and the size L on the plane 202. As can be seen, θ_{fov} equals 2×tan⁻¹(L/(2×D)).

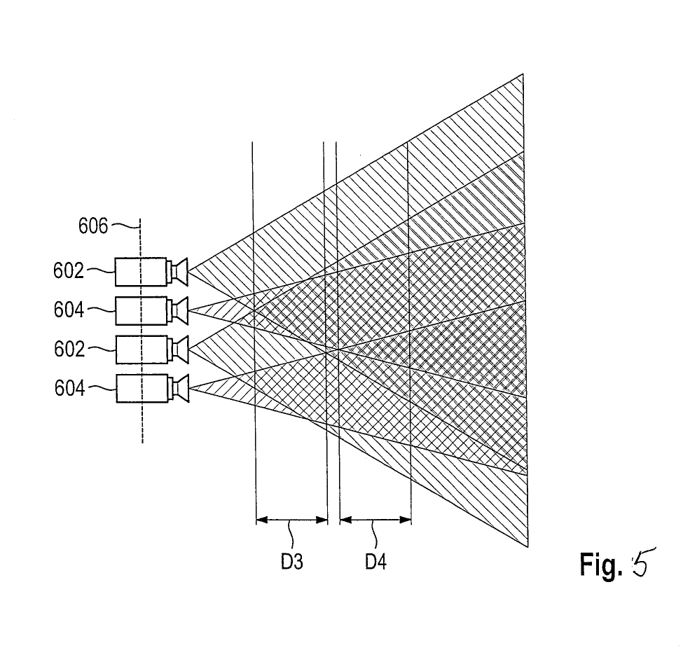

FIG. 5 shows a preferred arrangement in which two groups of microlenses 602, 604 having both different focal lengths and different fields of view (FOV) are arranged in a common plane 606. As can be seen the microlenses 602 with a wider field of view and a smaller focal length are used for focusing the virtual image space in a first depth range D3, and the microlenses 604 with a narrower field of view and a greater focal length are used for focusing the virtual image space in a second depth range D4 located further away from the common plane than the first range depth. In the first depth range D3 the microlenses 602 of the same, first group which are located next to each other have fields of view which overlap only by small amount. In the second depth range D4 the microlenses 604 of the same, second group which are located next to each other have fields of view which overlap only by a small amount. Note that for synthesizing an image from the micro images projected onto the photosensor array by the microlenses the micro images of adjacent microlenses do need a small overlap so that a small overlap of the different field of views of adjacent microlenses is needed. Thus, by using microlenses with different fields of views and different focal lengths the redundant information between micro images related to one focal length can be reduced. This limited redundancy between micro images gives more unique resolution per micro image and image plane.

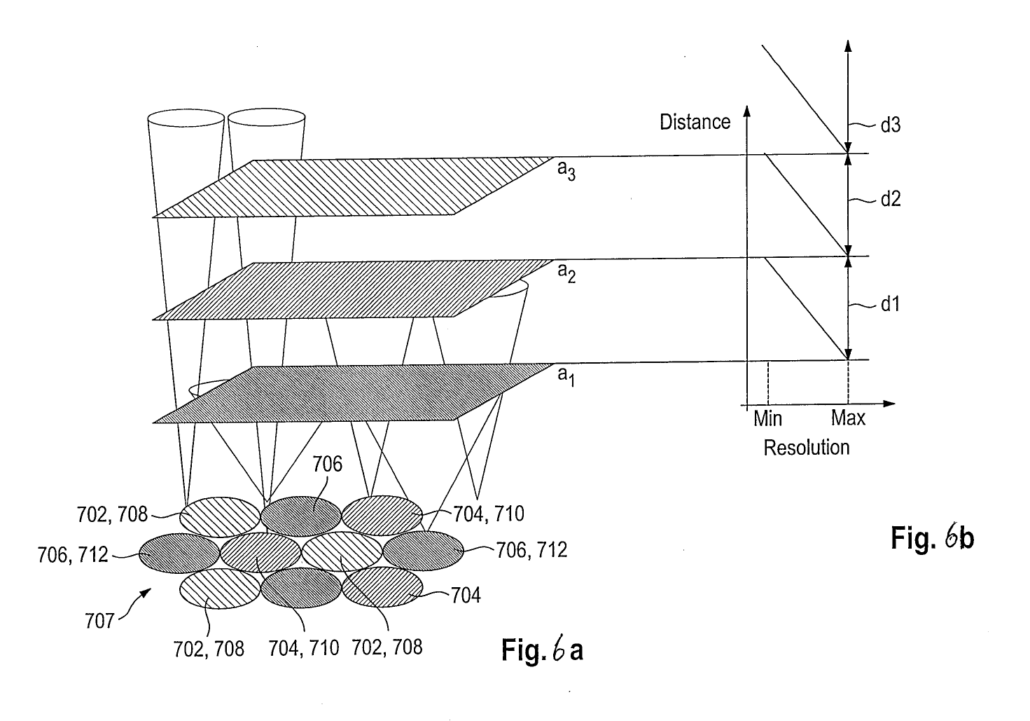

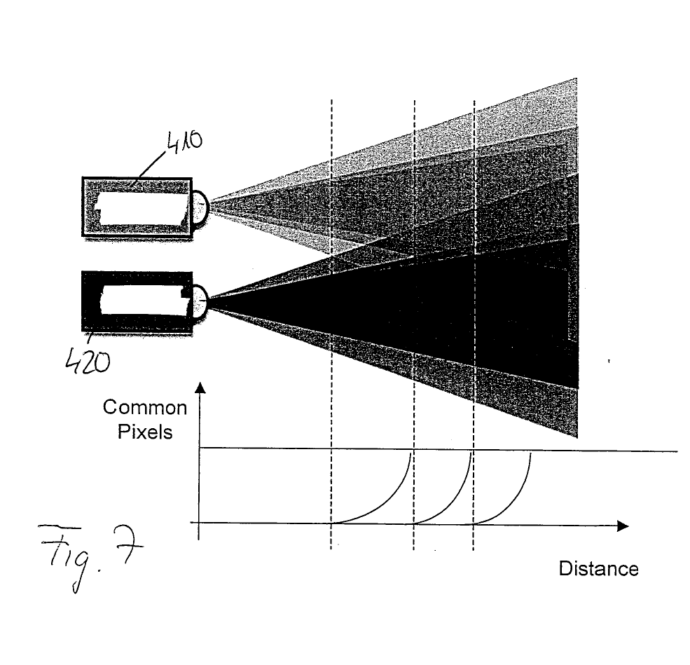

FIGS. 6a and 6b schematically illustrate the raw output resolution over the range of depth of an imaging system according to the present invention comprising microlenses having both different focal lengths and different fields of view. In the example of FIG. 6a three different groups of microlenses 702, 704, 706 are arranged in a microlens array 707 at a common plane. The first group of microlenses 702 comprises microlenses 708 with a first field of view and a first focal length, the second group of microlenses 704 comprises microlenses 710 with a second field of view and a second focal length, and the third group of microlenses 706 comprises microlenses 712 with a third field of view and a third focal length. The first field of view is wider than the second field of view, and the second field of view is wider than the third field of view. Further, the first focal length is smaller than the second focal length, and the second focal length is smaller than the third focal length. With this microlens arrangement the range of depth of the virtual image space is divided into different sub-ranges d1, d2, d3. The common focal length of the first group of microlenses 702 is chosen such that a “virtual” image at a distance a1 from the microlens array 707 can be brought into focus on a photosensor plane arranged with a predetermined distance from the microlens array, and the common field of view of the first group of microlenses 702 is chosen such that at the distance a1 from the microlens array the field of view of the microlenses 708 which are next to each other substantially do not overlap each other, i.e. only overlap by a very small amount. Likewise, the common focal length of the second group of microlenses 704 is chosen such that a “virtual” image at a distance a2 from the microlens array 707 can be brought into focus on a photosensor plane arranged with a predetermined distance from the microlens array 707, and the common field of view of the second group of microlenses 704 is chosen such that at the distance a2 from the microlens array the field of view of the microlenses 710 which are next to each other substantially do not overlap each other, i.e. only overlap by a very small amount. Likewise, the common focal length of the third group of microlenses 706 is chosen such that a “virtual” image at a distance a3 from the microlens array 707 can be brought into focus on a photosensor plane arranged with a predetermined distance from the microlens array 707, and the common field of view of the third group of microlenses 706 is chosen such that at the distance a3 from the microlens array the field of view of the microlenses 712 which are next to each other substantially do not overlap each other, i.e. only overlap by a very small amount. Thus, the range of depth is divided into sub-ranges d1, d2, d3 in each of which a particular group of microlenses can focus micro images of a “virtual” image onto a photosensor array without substantially overlapping each other or with overlapping each other by only a very small amount. As can be seen in FIG. 6b, due to this arrangement the resolution of the imaging system decreases from a maximum value Max to a minimum value Min in each sub-range d1, d2, d3 so that the overall resolution of the imaging system is enhanced over a large range of depth which is made by adding the sub-ranges d1, d2 and d3. The decrease of the resolution in each sub-range from a maximim value Max to a minimum value Min is due to the increasing overlapping of the fields of view of adjacent microlenses with same focal length and same field of view with increasing distance from the microlens array, i.e. with increasing distance within the respective sub-range. This can also be seen from FIG. 7 of the drawings, showing that the number of pixels common to adjacent microlenses 410, 420 arranged in a microlens array increases with increasing distance from the microlens array.

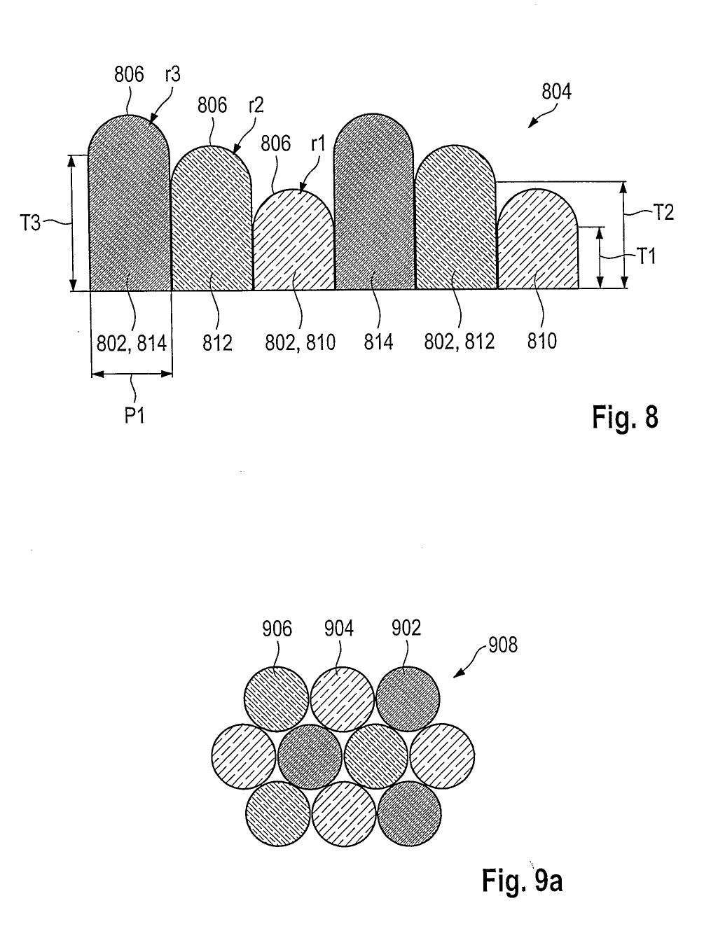

FIG. 8 schematically shows a preferred configuration of the microlenses of the digital imaging system. In the preferred configuration the plurality of microlenses 802 are arranged in a microlens array 804 and the focal lengths and the fields of view of the microlenses 802 are varying over the microlens array 804. The microlenses 802 are arranged with a predetermined pitch P1 to each other. For changing the field of view of a microlens 802 the radius of curvature of a lens surface 806 and/or the microlens thickness can be changed. In the present preferred configuration, microlenses 802 of different groups of microlenses both have lens surfaces 806 with different radii of curvature and different lens thicknesses so that a great difference between the different fields of view of different groups of microlenses is achieved. In the present example three different groups of microlenses 810, 812, 814 with lens surfaces 806 of three different radii of curvature r1, r2, r3 and three different glass thicknesses T1, T2, T3 are provided.

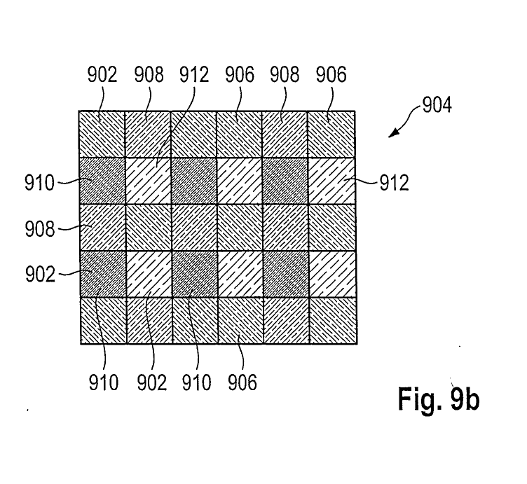

FIG. 9a shows a preferred distribution of three types of microlenses 902, 904, 906 in a hexagonal grid 908. The three different types of microlenses 902, 904, 906 differ in their focal lengths and their fields of view. Each microlens 902, 904, 906 in the grid 908 has a nearest neighbour microlens 902, 904 or 906, respectively, of a different type. The microlenses of a same type are also arranged in a hexagonal grid.

FIG. 9b shows a further preferred distribution of microlenses in an array. The microlenses 902 are arranged in a rectangular array 904 comprising four different types of microlenses 906, 908, 910, 912 which differ both in their focal lengths and their fields of view. The microlenses 906, 908, 910, 912 have a rectangular cross section. As in the embodiment of FIG. 9a each microlens 902 of a specific type 906, 908, 910, 912 is located adjacent to a microlens 902 of a different type to that specific type. The microlenses 902 of a same type 906, 908, 910, 912 are also arranged in a rectangular grid.

The embodiment of FIG. 9b has a better fill factor compared to the embodiment of FIG. 9a. The fill factor is the ratio of the active refracting area, i.e. the area which directs light to the photosensor, to the total contiguous area occupied by the microlens array.

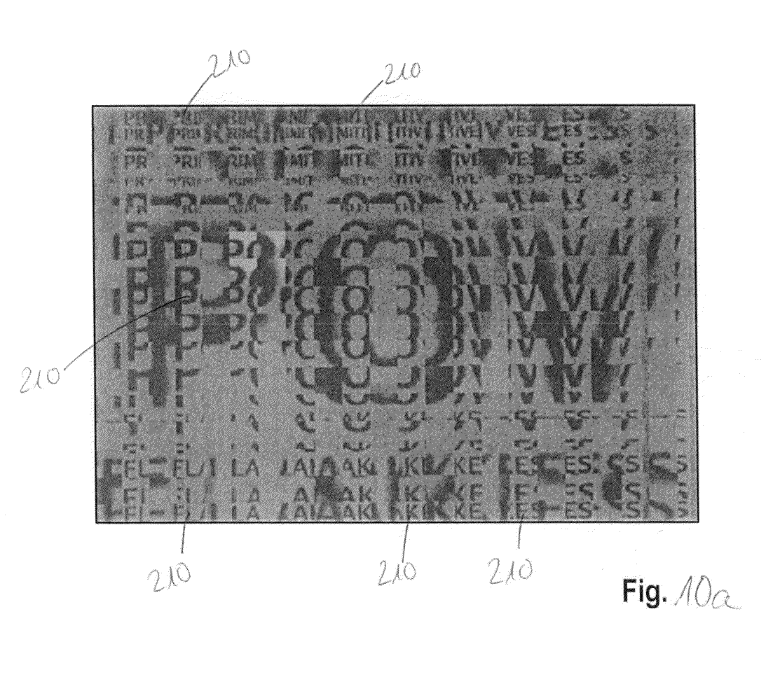

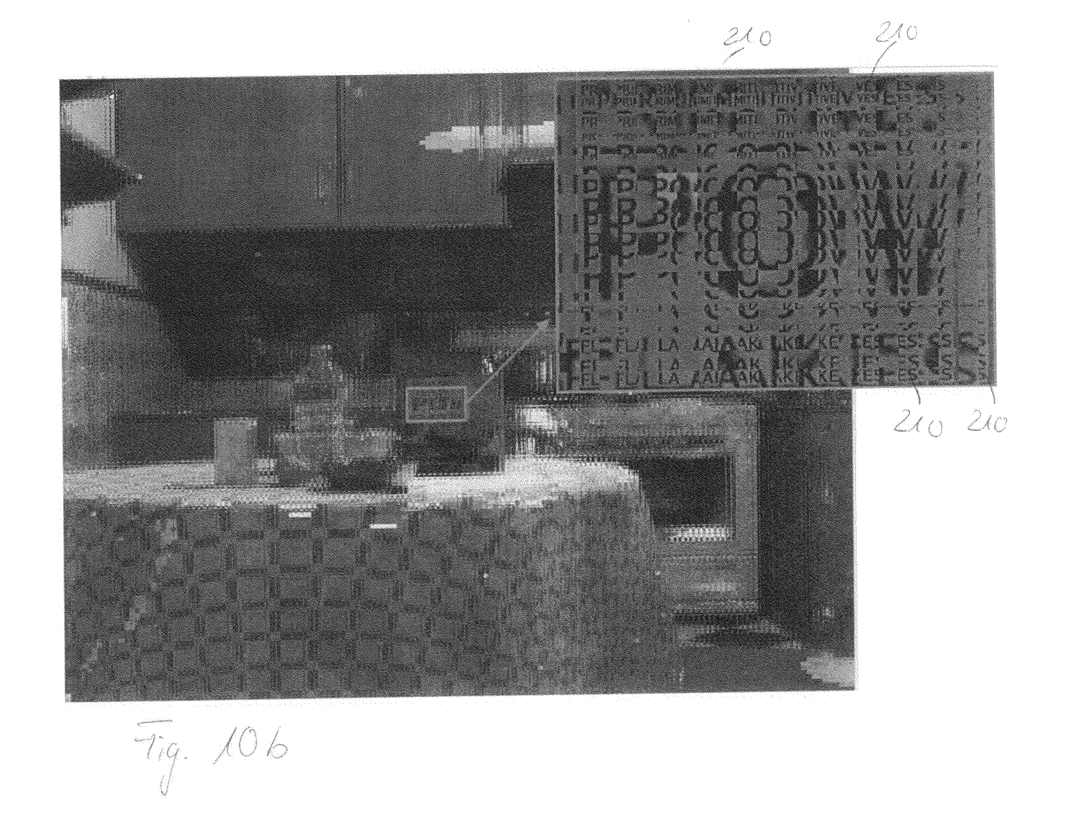

FIGS. 10a and 10b schematically illustrate micro images 210 generated by a microlens array with four different groups of microlenses having different focal lengths and different fields of view on a photosensor array of an imaging system according to the present invention. As can be seen, the micro images 210 generated by adjacent microlenses are shifted with each other thereby reducing redundant information between micro images related to one focal length. Further, as can be also seen, adjacent microlenses are related to different focal lengths thereby imaging an object over a large range of depth, and since microlenses with different focal lengths have different fields of view, the micro images related to different focal lengths are generated with high resolution.

With an imaging system according to the present invention depth sensing over continuous and longer imaging distance is possible. Further, digital refocusing is possible nearly without de-blurring. Also further, the required digital processing power is reduced since the micro images are all in focus over a large or the complete range of depth. Also, a variety of depth sensing principles can be applied at the same time (pixel shift, depth from defocus and depth from disparity).

The digital re-focusable images of an imaging system according to the present invention have lower resolution differences and do not need an excessive scaling and interpolation between the images of different depth positions, as nearly the same amount of pixels is used to form the final image. This enhances image quality. Furthermore different depth sensing algorithms can be implemented instead of commonly used pixel shift sensing between groups of microlenses. To enhance the depth map resolution depth from disparity is estimated by using groups of microlenses with large fields of view and opposite position at sensor area.

According to a further aspect of the present invention an optical design is used which compensates for the loss of resolution at larger distances of the object to the camera which is caused by the demagnifiaction of the lens array. The demagnification is compensated for by an optical effect called hypertelecentricity. This optical effect causes a larger magnification for objects located further away from the camera than for objects located nearer to the camera.

Although specific embodiments have been illustrated and described herein, it will be appreciated by those of ordinary skill in the art that a variety of alternative and/or equivalent implementations may be substituted for the specific embodiments shown and described without departing from the scope of the described embodiments. This application is intended to cover any adaptations or variations of the specific embodiments discussed herein. Therefore, it is intended that this invention be limited only by the claims and the equivalents thereof.

1. Digital imaging system for imaging an object, comprising
a photosensor array arranged in an image plane, and
a plurality of microlenses arranged so as to direct light from the object to said photosensor array,
wherein said plurality of microlenses have different focal lengths and different fields of view.

2. Digital imaging system of claim 1, wherein said plurality of microlenses are arranged in a microlens array.

3. Digital imaging system of claim 1, wherein said plurality of microlenses form a plurality of groups of microlenses, and wherein microlenses of a group have equal focal length and microlenses of different groups have different focal lengths.

4. Digital imaging system of claim 1, wherein said plurality of microlenses form a plurality of groups of microlenses, and wherein microlenses of the same group have equal field of view and microlenses of different groups have different fields of view.

5. Digital imaging system according to claim 4, wherein microlenses of the same group include lens surfaces with equal radius of curvature and equal lens thickness.

6. Digital imaging system of claim 1, wherein microlenses with equal focal length have equal field of view.

7. Digital imaging system of claim 1, wherein the field of view of each of said plurality of microlenses differs from the field of view of the microlenses adjoining to each of said microlenses.

8. Digital imaging system of claim 1, wherein said plurality of microlenses are arranged in a rectangular grid.

9. Digital imaging system of claim 8, wherein microlenses of a group of microlenses having equal field of view are arranged in a rectangular grid.

10. Digital imaging system of claim 1, wherein the field of view of each of said microlenses is selected from four different field of views.

11. Digital imaging system according to claim 1, further comprising a main lens for imaging said object, and said plurality of microlenses being arranged between said main lens and said photosensor array.

12. Digital imaging system according to claim 11, wherein said plurality of microlenses are arranged so as to project micro images of a virtual image of said object onto said photosensor array, said virtual image of said object being generated by said main lens.

13. Digital imaging system according to claim 3, wherein the equal focal length of a group of microlenses is chosen such that a virtual image at a predetermined distance from the microlens array can be brought into focus onto said photosensor array, and the equal field of view is chosen such that at said predetermined distance from said microlens array the field of view of microlenses of said group of microlenses which are located next to each other substantially do not overlap each other.
